(19) United States
(12) Patent Application Publication
(10) Pub. No.: US 2013/0145252 A1
(43) Pub. Date: Jun. 6, 2013

(54) PAGE BASED NAVIGATION AND PRESENTATION OF WEB CONTENT

(71) Applicant: Opera Software ASA, Oslo (NO)

(72) Inventors: Hakon Wium LIE, Oslo (NO); Lars Erik BOLSTAD, Oslo (NO)

(73) Assignee: OPERA SOFTWARE ASA, Oslo (NO)

(21) Appl. No.: 13/691,192

(22) Filed: Nov. 30, 2012

Related U.S. Application Data
(60) Provisional application No. 61/566,401, filed on Dec. 2, 2011.

(51) Int. Cl. G06F 17/22

(52) U.S. Cl. CPC G06F 17/2247
USPC 715/234

(57) ABSTRACT

A first aspect of the present invention is directed to a method whereby a web browser rearranges the content of a retrieved webpage into a sequence of discrete pages, each fitting within the viewport dimensions. According to the first aspect, the user can navigate the content by performing simple inputs interpreted as page-switching commands for viewing a next or previous discrete page. Further, according to a second aspect of the present invention, more than one discrete page can be displayed at a time. As such, the page-switching commands can be used for moving from the set of N (where N≧2) discrete pages currently displayed to the next or previous N discrete pages in the sequence.

### CROSS-REFERENCE TO RELATED APPLICATION

The present application is related to co-pending U.S. patent application Ser. No. 13/592,575, filed on Aug. 23, 2012.

### FIELD OF THE INVENTION

The invention relates to navigation and presentation of web content such as web pages and other web documents, and particularly to page based presentation and navigation inside web documents as well as between web documents.

### BACKGROUND OF THE INVENTION

When web media content such as web pages and other web documents are displayed by web browsers they are displayed as one large page that may extend outside the viewport created by the browser window, both in the horizontal and the vertical direction. When a user reads or looks at the content of a document, he or she must move the document relative to the viewport, known as scrolling, in order to see content that is outside the current position of the viewport.

Furthermore, the only relationship between documents are presented as links that can be invoked by a user in order to load a subsequent document after viewing the document currently loaded, or to invoke a “back” command in order to reload a previously loaded document in the browsing history, and a “forward” command in order to move forward in the browsing history after using the “back” command. Some web browsers also provide a “fast forward” and a “rewind” command—possibly using different names depending on the make of the browser—which can be invoked if the browser has detected a link in the current page that is assumed to be a link to a following or previous document in a set of related documents. Such an assumption can for example be based on the presence of words like “next,” “forward,” “previous” or “page 2” in a link attribute, the link text, or the URL of a hyperlink in a currently loaded document.

When users access web content using new devices with touch screens, for example tablets or smartphones, the gradual scrolling and the invoking of hyperlinks is less convenient for several reasons related to usability and convenience. As a result, small applications, known as “apps,” for reading or viewing content such as web pages and e-books have been turning towards a more traditional book-like presentation, where content is presented on a page by page basis such that users do not scroll gradually through the content. Instead the content is presented as entire pages, and the user can only move forward or back by going from one page to the next without any overlap of content between the two. However, this has required that content and the app be designed for each other. In particular, the content must be designed such that for example headlines, images and text can be displayed consistently on entire pages; the integrity of each page must be preserved; and many types of content, for example images, headlines and tables, cannot be allowed to span several pages.

### SUMMARY OF THE INVENTION

According to a first aspect of the present invention, a web browser is configured to rearrange the content of a retrieved webpage into sequential discrete pages, each sized to fit within the viewport dimensions. According to the first aspect, the user may be allowed to navigate the content by performing simple page-switching commands (e.g., “Page Up” and “Page Down”) which cause the next or previous discrete page to be displayed.

According to a second aspect of the present invention, each of the sequential discrete pages may be arranged so that its height corresponds (at least approximately) to a vertical dimension of the viewport, depending on the current display mode (e.g., landscape or portrait orientation) employed by the browser. Further, each of the discrete pages may be arranged so that its width is small enough with respect to the horizontal dimension of the viewport, depending on the current display mode, so that two or more of the discrete pages can fit side-by-side within the viewport. According to the second aspect of the present invention, the browser may display N discrete pages at a time (where N is an integer≧2), and the user may be allowed to navigate the content using simple page-switching commands which cause the next N or the previous N discrete pages to be displayed.

### BRIEF DESCRIPTION OF THE DRAWINGS

FIG. 1 illustrates the basic architecture of a computing device that can operate as either a client device or a server according to exemplary embodiments of the present invention;

FIG. 2 illustrates the basic architecture of a web browser implemented on a client device according to an exemplary embodiment of the present invention;

FIG. 3 is a flowchart illustrating an example implementation of a method consistent with a first aspect of the present invention for rearranging the content of a webpage into a sequence of discrete pages;

FIG. 4 is a flowchart illustrating an example implementation of a method for displaying more than one discrete page of webpage content at a given time, consistent with a second aspect of the present invention; and

FIG. 5 is a flowchart illustrating an example implementation of a method for navigating the sequence of discrete pages, consistent with the second aspect of the present invention

### DETAILED DESCRIPTION

The present invention seeks to improve or provide alternatives to the manner in which users traditionally access, view and navigate web content. Particularly, exemplary embodiments of the present invention are designed to provide a user with a presentation of content based on page views, and navigation of the document by transitioning between entire pages rather than through continuous scrolling. Exemplary embodiments also include a similar way of navigating between documents, e.g., the loading a new document from a currently loaded document may be invoked using the same or a similar command or input gesture as that used to move from one page to the next inside a document.

The principles of the present invention may be implemented in a mobile environment in which users are able to browse the Internet using their mobile devices (phone, tablet computer, etc.), e.g., via a 3G or 4G-compliant network or a wireless network based on Wi-Fi (IEEE 802.11), WiMAX (IEEE 802.16) or any other available standard for wireless communication. However, the present invention is not limited to a mobile implementation, and the principles described herein may also be applied to a desktop browsing environment.

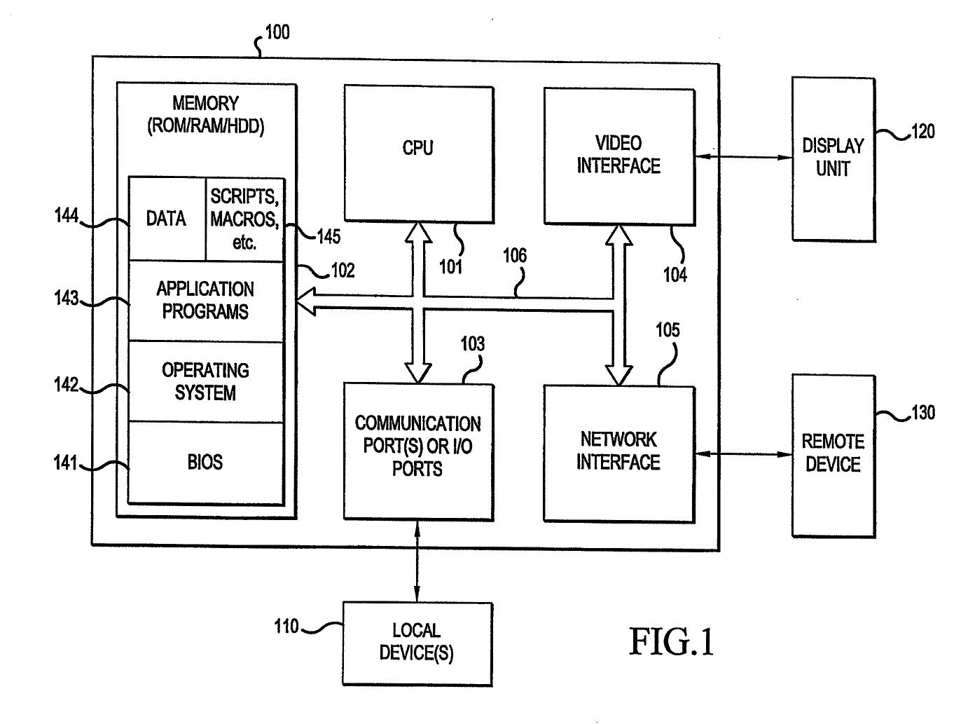

FIG. 1 illustrates a generalized computing device 100 that can be used as an environment for implementing various aspects of the present invention. For instance, the computing device 100 may be implemented as a client device, i.e., a user's computing device on which a web browser is installed to request webpages or resources from the server. Examples of such client devices include a mobile device (e.g., a cellphone, a smartphone, a tablet computer, etc.) or a general purpose desktop computer such as a PC. However, the computing device 100 of FIG. 1 may also be implemented as a server-side device, e.g., as a web server, a proxy server, or another specialized computing device as will be describe in more detail below.

In FIG. 1, a computing device 100 has various functional components including a central processor unit (CPU) 101, memory 102, communication port(s) 103, a video interface 104, and a network interface 105. These components may be in communication with each other by way of a system bus 106.

The memory 102, which may include ROM, RAM, flash memory, hard drives, or any other combination of fixed and removable memories, stores the various software components of the system. The software components in the memory 102 may include a basic input/output system (BIOS) 141, an operating system 142, various computer programs 143 including applications and device drivers, various types of data 144, and other executable files or instructions such as macros and scripts 145. For instance, the computer programs 143 stored within the memory 102 may include any number of applications, including a web browser and other web applications that may be executed in accordance with principles of the present invention.

In FIG. 1, the communication ports 103 may be connected to one or more local devices 110 such as user input devices, a printer, a media player, external memory devices, and special purpose devices such as, e.g., a global positioning system receiver (GPS). Communication ports 103, which may also be referred to as input/output ports (I/O), may be any combination of such ports as USB, PS/2, RS-232, infra red (IR), Bluetooth, printer ports, or any other standardized or dedicated communication interface for local devices 110.

The video interface device 104 is connected to a display unit 120 which may be an external monitor or an integrated display such as an LCD display. The display unit 120 may have a touch sensitive screen and in that case the display unit 120 doubles as a user input device. The user input device aspects of the display unit 120 may be considered as one of the local devices 110 communicating over a communication port 103.

The network interface device 105 provides the device 100 with the ability to connect to a network in order to communicate with a remote device 130. Such network, which in FIG. 1 is only illustrated as the line connecting the network interface 105 with the remote device 130, may be, e.g., a local area network or the Internet. The remote device 130 may in principle be any computing device (e.g., client or server) with similar communications capabilities as the device 100.

It will be understood that the device 100 illustrated in FIG. 1 is not limited to any particular configuration or embodiment regarding its size, resources, or physical implementation of components. For example, more than one of the functional components illustrated in FIG. 1 may be combined into a single integrated unit of the device 100. Also, a single functional component of FIG. 1 may be distributed over several physical units. Other units or capabilities may of course also be present.

In an exemplary embodiment, various aspects of the present invention may be incorporated into, or used in connection with, the components and/or functionality making up a web browser installed as an application on a device 100. While the terms “web browser” and “browser” are used throughout this specification, it should be understood that such terms are not intended to limit the present application only to traditional web browser programs, but instead cover any type of user agent or web application that is capable of sending URL requests for data resources (including, but not limited to, web pages) over the World Wide Web consistent with the principles of the present invention. Certain embodiments of the invention may also involve applications that access content that has already been made available locally without communicating with other networked devices.

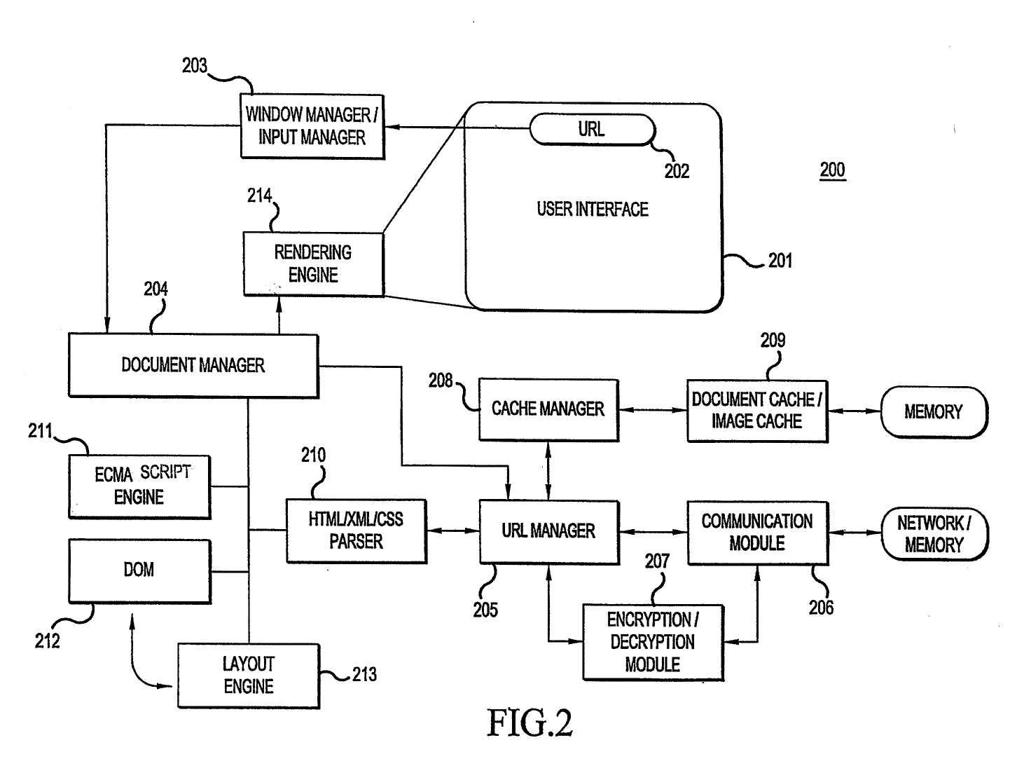

FIG. 2 illustrates the basic architecture of a web browser 200 that can be used in connection with the present invention. Particularly, FIG. 2 shows an example of various modules that may be present in such a web browser 200. The modules will typically be software modules, or otherwise implemented by a programmer in software, and may be executed by the CPU 101. However, it is also possible for any of the modules of FIG. 2 to be implemented as hardware, a combination of hardware and software, or “firmware,” as will be contemplated by those skilled in the art.

The web browser 200 presents the user with a user interface 201 that may be displayed on the display unit 120 shown in FIG. 1. The user interface 201 may include an address field 202 in which the user may input or select the URL of a document or a service he or she wants the browser 200 to retrieve. For example, the user may use an input device (e.g., keyboard) to type in the URL in the address field 202. The address field 202 may also be a link that is displayed and may be activated by the user using a pointing device such as a mouse. Alternatively the URL may be specified in the code of a document or script already loaded by the web browser 200.

In any case, the URL may be received by a window and input manager 203 that represents the input part of the user interface 201 associated with, or part of, the browser 200. The URL may then be forwarded to a document manager 204, which manages the data received as part of the document identified by the URL.

The document manager 204 forwards the URL to a URL manager 205, which instructs a communication module 206 to generate a web page request, i.e., a request for access to the identified resource. The communication module 206 may be capable of accessing and retrieving data from a remote device 130 such as a server over a network using the hypertext transfer protocol (HTTP), or some other protocol such as HTTP Secure (HTTPS) or file transfer protocol (FTP). The communication module 206 may also be capable of accessing data that is stored in the local memory 102 of the computing device 100.

Referring again to FIG. 2, the web browser 200 may include an encryption/decryption module 207 to handle communication between the URL manager 205 and the communication module 206, if communication outside the computing device 100 is required to be encrypted (e.g., as specified by the protocol used for accessing the URL).

The data received by the communication unit 206 in response to a webpage request is forwarded to the URL manager 205. The URL manager 205 may then store a copy of the received content in local memory 102 using a cache manager 208 which administers a document and image cache 209. If the same URL is requested at a later time, the URL manager 205 may request it from the cache manager 208, which will retrieve the cached copy from the cache 209 (unless the cached copy has been deleted) and forward the cached copy to the URL manager 205. Accordingly, it may not be necessary to retrieve the same data again from a remote device 130 when the same URL is requested a second time.

The URL manager 205 forwards the data received from the communication port 206 or cache 209 to a parser 210 capable of parsing content such as HTML, XML and CSS. The parsed content may then, depending on the type and nature of the content, be processed further by an ECMAScript engine 211, a module for handling a document object model (DOM) structure 212, and/or a layout engine 213.

This processing of the retrieved content is administered by the document manager 204, which may also forward additional URL requests to the URL manager 205 as a result of the processing of the received content. These additional URL's may, e.g., specify images or other additional files that should be embedded in the document specified by the original URL.

When the data representing the content of the specified document has been processed it is forwarded from the document manager 204 in order to be rendered by a rendering engine 214 and displayed on the user interface 201.

The various modules thus described are executed by the CPU 101 of computing device 100 as the CPU 101 receives instructions and data over the system bus(es) 106. The communications module 206 communicates with the remote device 130 using the network interface 105. The functionality of various modules in FIG. 2 may of course be integrated into fewer larger modules. Also, the functionality of a single module in FIG. 2 may be distributed or replicated over several modules.

It will further be understood that, while the web browser 200 described above may be implemented as an application program 143 of the computing device 100, some of the browser's 200 functionality may also be implemented as part of the operating system 142 or even the BIOS 141 of the device 100. Further, the content received in response to a webpage request may include data 144, script 145, or a combination thereof.

A webpage is a document typically written in HTML, XHTML or other similar markup languages. Often, HTML pages are styled with CSS style sheets and combined with images (e.g., in JPEG, GIF or PNG formats), video (e.g., in the WebM format) or plugins (e.g., in the SWF format) in order to form comprehensive visual presentations. These presentations, which are typically generated by the rendering engine 214 of a web browser 200, as described above in connection with FIG. 2, often require more space than a user's computer screen or user interface 201 can offer. Typically, web browsers have solved this problem by offering a vertical scrollbar on the side of the webpage so that the user can scroll from the top to the bottom of the web page. Likewise, when the webpage is wider than the user's computer screen, a horizontal scrollbar is offered. By using these scrollbars, the user is able to view the entire web page.

Scrollbars, however, are inconvenient in some circumstances. Some computers, typically of the ‘tablet’ kind, do not have a mouse (which is typically used with scrollbars). Also, some of the screens used by tablet computers are of the ‘electronic paper’ kind which takes about a second to refresh; this is too slow for use with scrollbars or other methods of continuous scrolling.

To overcome the limitations of scrollbars, a first aspect of the present invention is directed to an alternative method of presenting webpages to users. Instead of scrolling a webpage, the webpage is split into one or more sequential discrete pages such that each discrete page is no bigger than the space available in the viewport at a given time. According to this aspect of the invention, the user is given the ability to perform simple manipulations or gestures each interpreted by the browser 200 as a command to change the discrete page(s) currently displayed in the viewport. Such command may be used to switch discrete pages incrementally or decrementally according to the particular sequence in which the discrete pages have been arranged. For instance, in an embodiment where the browser 200 is configured to display the discrete pages one at a time, the user might be able to command the browser 200 to move from one discrete page to the next by selecting a “Page Down” button or key, performing a touchscreen gesture (e.g., quick swipe in a particular direction), or using some other mechanism. Likewise, the user might be able to command the browser 200 to move to the previous discrete page by selecting a “Page Up” button or key, performing a different touchscreen gesture (e.g., quick swipe in the opposite direction), or using some other mechanism. Through the use of such page-switching commands, the user could navigate the content of the webpage without scrolling, and in a manner particularly suitable for tablets and smaller screens.

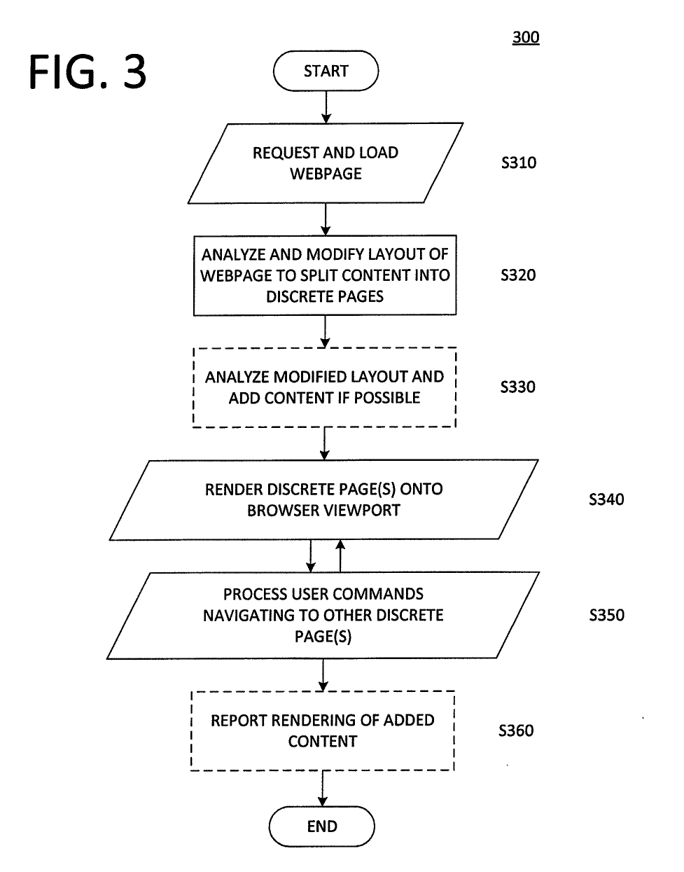

FIG. 3 is a flowchart illustrating an example implementation of a method consistent with a first aspect of the present invention. As illustrated in FIG. 3, the method 300 starts by requesting and loading a webpage according to operation S310. For example, in S310, the webpage is requested and loaded as described above with reference to FIG. 2. As part of operation S310, any embedded content of the webpage, such as images and content requiring plug-ins (e.g., SWF file), may be received by the web browser 200.

Thereafter, the webpage is processed according to operation 8320 in order to analyze and modify the layout of the webpage so that the content will be rendered by the web browser 200 as a sequence of discrete pages that can be navigated without the use of scrollbars and without the need to repeatedly panning/dragging operations. Such analysis and modifications may be performed, e.g., by the rendering engine 214 of the web browser 200. According to S320, various heuristics or rules may be used to categorize the different parts of the content, and determine if and how particular elements should be modified. These heuristics may be implemented entirely in the browser 200. No special code is needed in the markup language document in order for discrete pages to be used; the browser 200 may use heuristics and normal CSS code to determine how to break the webpage into one or more discrete pages.

For example, in S320, webpage elements may be categorized based on tags in the markup language code, media type and CSS code. As such, content could, for example, be classified into one of multiple classifications such as: heading material, body text or main content, content supplemental to the main content (e.g., image or content requiring a plug-in), advertising, footer, legal disclaimer, sidebar or navigation bar content, part of an index to related content, etc. Based on such categorizations, the rendering engine 214 may be able to enforce certain rules in order to modify elements and/or the relationships between multiple elements on the webpage, so that the webpage content can be split into multiple discrete pages.

An example of such a rule could be that, if the webpage represents a topical article in a website, an image in the webpage should be placed on the front page, i.e., the first discrete page, and it should be scaled to take up approximately 30% of the available space. Another possible rule may specify that advertising should be placed on the first discrete page. Alternatively, the rule may specify that advertising be placed on the last discrete page (i.e., at the end of the article) if there is unused space on the last discrete page. According to another rule, any legal disclaimer may be placed on the last discrete page, possibly in addition to advertising. Alternatively, a rule may indicate that the disclaimer is to be placed at the bottom of every discrete page.

It will be understood that the same rules do not necessarily have to be applied in each and every webpage. Instead, according to some embodiments of the invention, the choice of which rules are applied is made dynamically based on the characteristics of the loaded webpage. For example, the ratio of images to text in a webpage may be determinative of whether a rule will be applied to scale images to a particular percentage of each discrete page. As another example, some webpages may be rendered with a legal disclaimer on the bottom of each discrete page, while other webpages are rendered with a legal disclaimer only on the bottom of each discrete page.

The choice of rules may also be dependent on a current display mode employed by the browser 200, e.g., whether it is displaying according to a landscape or portrait orientation.

Furthermore, in an exemplary embodiment, the particular rules or heuristics applied in S320 may be tailored to the viewport dimensions of the computing device 100 in which the web browser 200 is installed. For instance, the rules may be designed to make sure that each discrete page fits within the screen dimensions of the device 100, and more particularly, within the dimensions of the browser viewport.

Furthermore, it might be possible for the main browser window or the viewport to be resized while the web browser 200 is run. As a specific example of this, the computing device 100 may be capable of sensing that the user has changed the way he is holding the device 100, and switch the display mode from landscape to portrait orientation, or vice versa, as appropriate. However, it is also be possible that the user could resize the main browser window (and thus the viewport) in other ways. To deal with such changes, the rules employed in S320 can be made dynamically adaptable to the current dimensions of the browser viewport. For instance, even after operation S320 has been executed, it would be possible to configure the browser 200 to detect any resizing of its main window or viewport that occurs while the discrete pages are being viewed, and then repeat S320 in order to adapt the size and shape of the discrete pages to the new viewport dimensions.

In addition, it will be understood by those with skill in the art that the selection of heuristics and the way they are tuned to each other in order to organize and scale content in a preferred manner is a matter of design choice and that it is impossible to provide a complete list of content categorization, rules and tuning parameters. However, techniques that have been used in order to adapt webpages to small and medium size displays are among those that can be adapted to the present invention. Such techniques are, for example, described in U.S. patent applications Ser. Nos. 10/654,455, 10/956,019, 10/936,552, 11/267,316, 10/982,953, 11/517,524, 11/525,177, and 12/423,968, each of which is hereby incorporated by reference in its entirety.

Furthermore, operation S320 may be designed to honor any CSS properties that would influence pagination. For instance, conventional web browsers need to perform pagination when printing documents, and CSS provide certain elements to influence where the page breaks can occur (see, e.g., “Cascading Style Sheets Level 2 Revision 1 (CSS 2.1) Specification,” Jun. 7, 2011 Recommendation, edited by Bert Bos et al., published by World Wide Web Consortium (W3C), Chapter 13 (“Paged media”), the entire contents of which are herein incorporated by reference). Examples of the CSS properties that may be defined in a webpage in regard to pagination include: “h1 {page-break-before: always},” “blockquote {page-break-after}” and p {orphans: 1, windows 1}.” According to an exemplary embodiment of the present invention, the web browser 200 may be designed to analyze the CSS properties regarding pagination when modifying the layout in S320, so that the discrete pages are defined in accordance with such properties.

Referring again to FIG. 3, after operation S320 has been performed, it might be common for the last discrete page to have a blank area. The size, shape, and locations of the blank areas in the modified webpage (i.e., sequence of discrete pages) will vary based on factors such as the heuristics used for splitting the content into discrete pages, the size and shape of the discrete pages (which may be dictated by the size and shape of the screen of the computer device 100), the size of the fonts used, etc. Further, there may be additional content (e.g., advertisements) which can be presented within such blank spaces. The browser 200 may therefore be configured to retrieve and display such additional content.

Thus, operation S330 may be performed by the browser 200 in order to analyze the modified layout to find blank areas, and provide additional content to be presented within the blank areas. The performance of operation S330 may be optional (as depicted by the dotted lines). For instance, it could be made dependent on factors including whether the browser 200 has been configured to retrieve such content from a compatible repository, whether the source website has made additional content available, and whether the user of the web browser 200 activates a setting to allow for the addition of such content.

As an example, operation S330 may be used to insert additional advertisements to the available blank areas. In this example, S330 may need to analyze the size and shape of any available blank areas, and then select from available advertisements (e.g., in a database) those which best match the respective blank areas based on their size and shape (and possibly other factors such as user profile, browsing history, contents of the current page etc.). The selected advertisements are then made available for display in the blank areas when the corresponding discrete pages are rendered.

Referring again to FIG. 3, after the layout is modified (and content is possibly added), the webpage content may be rendered by the browser 200 and navigated by the user as a sequence of discrete pages as shown in S340 and S350. Particularly, the browser 200 may render a discrete page (or possibly multiple discrete pages) in the viewport according to operation S340. The browser 200 is further capable of processing page-switching commands input by the user according to operation S350, so that the browser 200 can display the desired discrete page(s) in S340. As mentioned earlier, the user may move between discrete pages using keys/buttons, simple touchscreen gestures or another mechanism representing “Next Page” and “Previous Page” commands. Further, it can be convenient to represent the discrete pages as having not only logical (sequential) locations, but also having relative physical locations. For instance, the next discrete page in the sequence could be represented as being below the current discrete page, while the previous page could be represented as being above the current discrete page. In this example, the user would move the viewport downward to go to the next discrete page (i.e., perform a “Page Down” command, and move the viewport upward to go to the previous discrete page (i.e., perform a “Page Up” command).

In addition, the sequence of discrete pages could be considered to be “looped” according to one exemplary embodiment. I.e., when the user is at the last discrete page, a “Page Down” command could be used to navigate back to the first discrete page. Similarly at the first discrete page, a “Page Up” command could be used to move to the last discrete page in the sequence. According to an alternative exemplary embodiment, however, a “Page Down” command at the last discrete page of a particular webpage could be used to navigate to an entirely different webpage or document (which could be considered the “next” webpage/document). Further, in this alternative embodiment, a “Page Up” command at the first discrete page might be used to navigate to a “previous” webpage/document.

Other types of page-switching commands may also be provided with regard to S350. These additional page-switching commands could also be defined directionally with regard to the current discrete page (e.g., as “Page Right” and/or “Page Left” commands). For example, at a given discrete page, the user might be able to move the viewport to the right (i.e., perform a “Page Right” command) to display an “index” of the current webpage/document.

Furthermore, each discrete page may be provided with a “map” describing what would be displayed by moving the viewport above, below, to the left, and/or to the right of the discrete page. For instance, for the last discrete page of a sequence, the “map” might indicate that the “next” webpage/document is located below (and thus displayable by performing a “Page Down” in S350), and also that the “index” is located to the right (and thus displayable by performing a “Page Right” in S350).

Although the particular examples above indicate that the user can navigate the discrete pages of a particular webpage/document by moving up and down (i.e., using “Page Up” and “Page Down” commands), this is not limiting on the present invention. As an alternative, the sequence of discrete pages can be navigated by moving to the left and right (i.e., using “Page Left” and “Page Right” commands). In this instance, a “Page Up” at each discrete page could be used for, e.g., displaying an “index” of the document.

After the user is done viewing the webpage content (e.g., the user requests a different webpage or closes the browser), the browser 200 may optionally be configured to report (e.g., to an external server) whether any additional content was added to blank spaces within the rendered discrete pages. This is illustrated in S360 of FIG. 3. For instance, such an operation may allow a source website or other entity to track which advertisements have been used, possibly to receive financial compensation from an advertiser. As illustrated by the dotted lines, however, the performance of operation S360 is optional.

It should be noted that a point of novelty of the method of the first aspect of the present invention described above is that, whereas conventional web browsers have utilized pagination algorithms solely for the purpose of printing a webpage or portion thereof, the present invention applies the concept of pagination to the display and navigation functions of a browser 200.

Although the above description included examples in which the user can navigate pages by pressing a keyboard button or a touchscreen gesture to change the discrete page(s) displayed, other types of simple inputs can be used. For instance, instead of using touchscreens gesture, the user may be able to switch to the next/previous discrete page in the sequence through other types of gesture such as by moving a joystick in the right/left or up/down direction. Similar directional gestures may also be performed using an electronic mouse or trackball device. Furthermore, as an alternative to keyboard buttons, other types of buttons (e.g., mouse button, ‘virtual’ on-screen button, or dedicated hardware button) may be pressed or clicked by the user to switch the discrete page(s) that are displayed. Moreover, it might be possible to use a combination of buttons or gestures, rather than a single button or gesture, to perform certain page-switching commands.

The first aspect of the present invention provides an effective way of navigating within webpages without the use of scrollbars. However, this first aspect has been mainly described above according to an example embodiment in which the discrete pages are displayed one at a time. A second aspect of the present invention provides a way in which multiple discrete pages are displayed by the browser 200 at a given time, while still allowing the webpage content to be navigated without the use of scrollbars or repeated dragging or panning.

The second aspect can be thought of as an extension or particular implementation of the first aspect of the present invention. According to the second aspect, each of the sequential discrete pages may be arranged so that its height corresponds (at least approximately) to the vertical dimension of the viewport. Further, each of the discrete pages may be arranged so that its width is small enough with respect to the horizontal dimension of the viewport so that two or more of the discrete pages can fit side-by-side within the viewport.

Accordingly, in accordance with the second aspect of the present invention, a browser 200 may display N discrete pages at a given moment (where N is an integer≧2), and the user may be allowed to navigate the content using simple page-switching commands which cause the next N or the previous N discrete pages to be displayed.

As mentioned above, the second aspect of the invention can be considered a particular implementation of the first aspect described above. For instance, to implement the second aspect, the shape and size of the discrete pages should be configured so that N discrete pages can fit within the viewport at the same time. This could be accomplished by programming the rules of operation S320 of FIG. 3 to set the width of each discrete page to be no more than (1/N)-th the size of the viewport's horizontal dimension, thereby allowing N discrete pages to fit side-by-side within the viewport. The height of each discrete page could be set approximately equal to the vertical dimension of the viewport in this case.

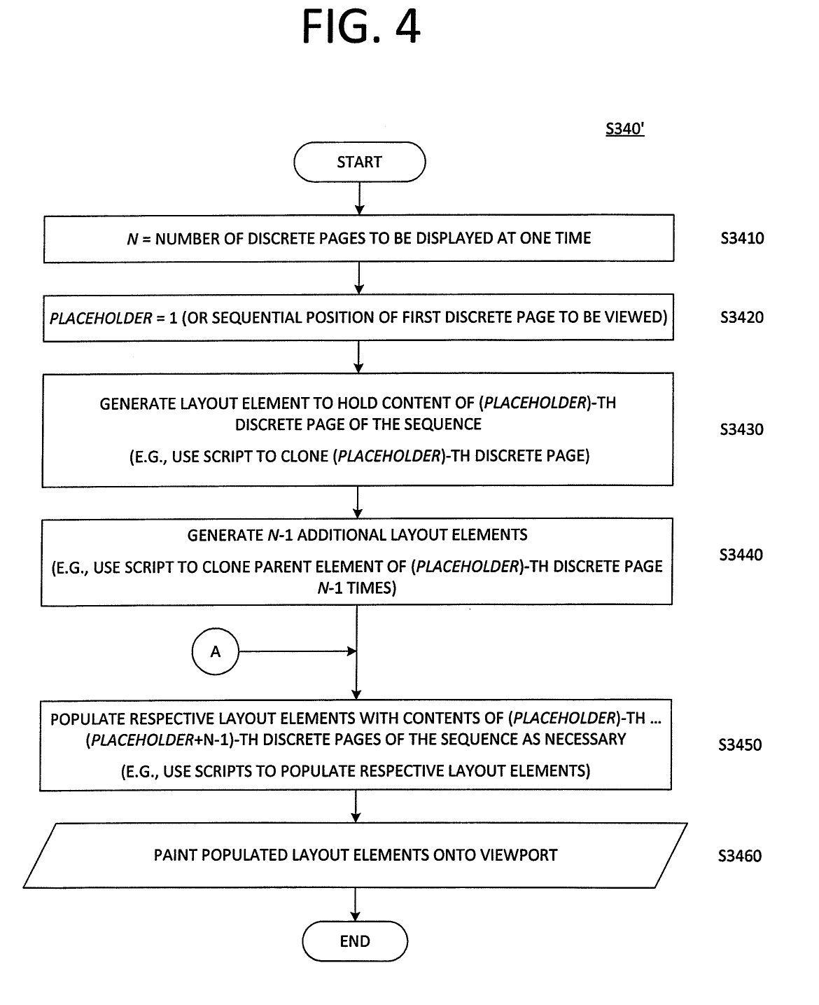

In addition, operation S340 of FIG. 3 can be specifically arranged to render N discrete pages in the browser viewport at the same time, in order to implement the second aspect of the present invention. FIG. 4 is a flowchart illustrating a process S340′ that can be used for carrying out operation S340 of FIG. 3 in a manner that is consistent with the second aspect.

With reference to FIG. 4, operation S3410 determines the number of discrete pages to be displayed at the same time as parameter N (N being an integer≧2). According to an exemplary embodiment, N could be programmed into the browser 200 as a non-varying value. Alternatively, the value N can be made adaptable according to user preference, an operating mode of the browser 200, or data within the webpage.

According to operation S3420, a parameter PLACEHOLDER is initialized. The PLACEHOLDER parameter represents a location in the sequence of discrete pages, and defines which of the discrete pages will be presented to the user at a given time. For instance, the web browser 200 may be programmed to display the (PLACEHOLDER)-th discrete page of the sequence side-by-side with each of the next N−1 discrete pages in the sequence. In a particular example, the browser 200 may be configured to layout the N discrete pages in the viewport in order from left to right, such that the (PLACEHOLDER)-th discrete page is rendered at the leftmost position and the (PLACEHOLDER+N−1)-th is rendered at the right-most position.

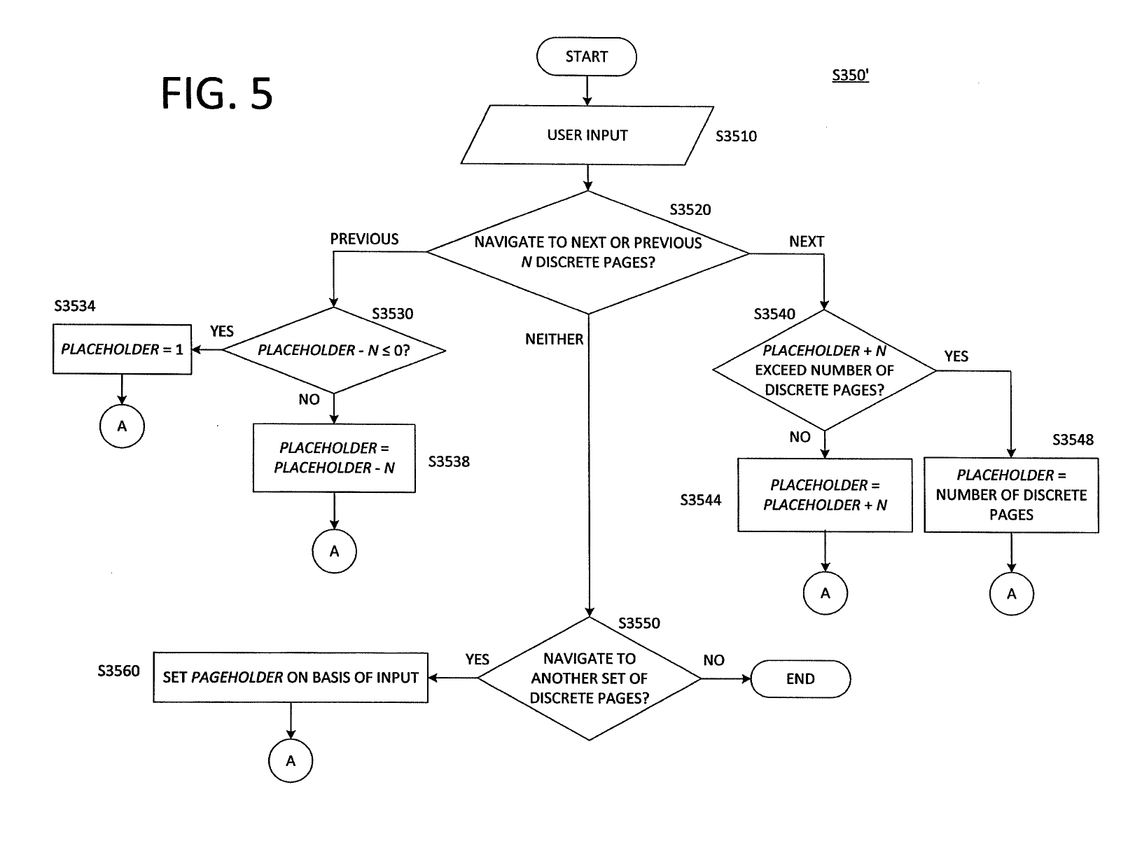

As will be described in connection with FIG. 5 below, PLACEHOLDER can be used as a counter which is incremented or decremented by N as the user navigates to next N or previous N discrete pages. Although particular examples are described below in which only one PLACEHOLDER counter is maintained, the invention is not limited as such. A possible alternative would be to maintain N different counters (e.g., PLACEHOLDER_1, PLACEHOLDER_2, etc.) corresponding to the sequential positions of the respective N discrete pages that are displayed at a given time. For instance, it would require only minor modifications to implement the principles described below using multiple counters whose values maintain a constant relationship with one another (e.g., the value of PLACEHOLDER_2 is always 1 greater than PLACEHOLDER_1, etc.).

Referring again to S3420 of FIG. 4, the PLACEHOLDER counter may be initialized to a value representing a sequential position of the discrete page to be viewed first by the user. Typically, this means that PLACEHOLDER would be initialized to the value of 1, which represents the first discrete page in the overall sequence. However, it is also possible that PLACEHOLDER could be initialized to another value in S3420, for example, if the user is given the option to choose which of the discrete pages he wants to view first.

The contents of the N discrete pages to be displayed are then laid out in operations S3430 and S3440 of FIG. 4. Specifically, operation S3430 generates the layout box to hold the contents of the (PLACEHOLDER)-th discrete page. As discussed above, this layout box can have a height approximately equivalent to the vertical dimension of the viewport, but a width of no more than (1/N)-th the size of horizontal dimension of the viewport. However, this need not always be the case. For instance, the height of the discrete pages may be made smaller than the vertical dimension, e.g., to allow for a banner (e.g., advertisement), menu, or other element to be inserted across the top or bottom of the screen when the N discrete pages are displayed. Similarly, the width of the discrete pages may be made smaller than (1/N)-th the size of the horizontal dimension, e.g., to allow for a similar element to be inserted along either side of the screen. It should be noted that what constitutes the ‘vertical’ and ‘horizontal’ dimensions relative to a computing device 100 may change depending on whether the device 100 is capable of switching its display mode between landscape and portrait orientations.

According to S3430, a layout element is generated to hold the contents of the (PLACEHOLDER)-th discrete page. For example, each of the discrete pages may be defined (e.g., in accordance to S320 of FIG. 3) as a series of one or more hierarchically-arranged elements. As such, S3430 could generate the layout element by utilizing a relatively simple script to clone the parent element of the (PLACEHOLDER)-th discrete page containing all of the child elements.

As a particular example, each discrete page may be defined in CSS code as a series of nested layout boxes. In this particular example, S3430 could utilize a script to clone the parent or top-level CSS box of the (PLACEHOLDER)-th discrete page, thus capturing the entire contents and properties contained therein.

Referring again to FIG. 4, layout elements are also generated to hold the respective contents of the next N−1 discrete pages of the sequence, as shown in S3440. For example, this could be accomplished by further cloning the parent element (e.g., top-level CSS box) of the (PLACEHOLDER)-th discrete page N−1 more times.

Furthermore, in S3440, the thus-generated layout elements may be laid out in an appropriate manner, e.g., side-by-side with the layout element of the (PLACEHOLDER)-th discrete page. For example, the layout element of the (PLACEHOLDER)-th discrete page could be laid out at the leftmost portion of the screen, and to the right of it the layout element of the (PLACEHOLDER+1)-th discrete page, and so forth. Furthermore, a script can be utilized to generate and layout the additional layout elements in S3440.

Referring again to FIG. 4, the layout elements generated in S3430 and S3440 are populated, as necessary, with their appropriate contents (and properties) in S3450. When the S3450 is first performed, it might not be necessary to populate the contents of the layout element of the (PLACEHOLDER)-th discrete page since it might already contain the appropriate contents as a result of S3430. However, when the user decides to navigate to another set of N discrete pages (and the value of PLACEHOLDER changes), operation S3450 may need to be repeated at which time the layout element for the (PLACEHOLDER)-th discrete page would be repopulated with updated contents, similar to the other layout elements. A script may also be used in S3450 to populate each of the layout elements with the contents of the corresponding discrete page.

When the layout elements have been populated with appropriate contents in S3450, these layout elements may be rendered onto the browser viewport according to S3460.

As described above in connection with the first aspect of the invention (particularly, operation S350 of FIG. 3), it was described that the user could perform page-switching commands in order to navigate the sequence of discrete pages as they are rendered. The same also applies to the second aspect. Particularly, FIG. 5 is a flowchart illustrating a process S350′ that can be used to carry out operation S350 of FIG. 3 in a manner that is consistent with the second aspect of the invention.

For purposes of convenience, it is assumed that a set of N discrete pages are already rendered onto the viewport (in accordance with the process S340′ of FIG. 4) as the process S350′ of FIG. 5 is commenced. As such, it is assumed that the parameters of PLACEHOLDER and N have already been initialized prior to the user inputting any navigational commands in accordance with FIG. 5. However, this does not mean that user inputs cannot be used to decide the initial value of N and/or PLACEHOLDER in accordance with FIG. 4.

With reference to FIG. 5, the user inputs a command according to S3510. For instance, this may be one of the simple page-switching commands described above in the first aspect. As such, it is possible in S3510 for the user to perform an input representing a “Page Up” (i.e., “Previous Page”) command or a “Page Down” (i.e., “Next Page”) command. Similar to the first aspect of the invention, these commands may require only a simple interaction by the user like a button, quick gesture, or some other mechanism. However, according to the second aspect, these commands can be interpreted somewhat differently, i.e., interpreted to mean that the user wants to switch the display from the current N discrete pages to either the previous N discrete pages or the next N discrete pages in the sequence. Such commands could be carried out by decrementing or incrementing the current value of PLACEHOLDER to an appropriate value, and return processing to S3450 of FIG. 4 (as indicated by reference element “A”) to update the layout elements with the contents of the appropriate discrete pages.

Specifically, it can be decided in S3520 of FIG. 5 whether the user input should be interpreted as a “Previous N Pages” command or a “Next N Pages” command. If it is to be interpreted as a “Previous N Pages” command, processing proceeds to S3530 where it is further decided whether decrementing the PLACEHOLDER counter by N would cause the resultant value to point to an invalid position in the sequence of discrete pages (i.e., whether PLACEHOLDER−N≦0). If this is the case, the value of PLACEHOLDER is set to 1 (first position in the sequence) in S3534 and processing returns to S3450 of FIG. 4. However, if PLACEHOLDER could be decremented by N and still refer to a valid position in the sequence, then PLACEHOLDER is decremented by N in S3538 and processing returns to S3450 of FIG. 4.

If, on the other hand, S3520 of FIG. 5 decides that the user input should be interpreted as a “Next N Pages” command, processing proceeds to S3540. At S3540, it is further decided whether incrementing the PLACEHOLDER counter would return a value pointing to an invalid position in the sequence (i.e., whether PLACEHOLDER+N exceeds the total number of discrete pages in the sequence). If so, processing proceeds to S3548 where PLACEHOLDER is set to the total number of discrete pages (which corresponds to the last valid position in the sequence), and processing then returns to S3450 of FIG. 4. On the other hand, if it is decided that PLACEHOLDER could be incremented by N and still point to a valid sequence position, PLACEHOLDER is incremented by N in S3544 and processing then returns to S3450 of FIG. 4.

However, referring again to FIG. 5, it is also possible that the user input of S3510 should be interpreted as neither a “Previous N Pages” command nor a “Next N Pages” command. It this is the case (as decided in S3520), processing may proceed to S3550. For instance, as described above in connection with the first aspect of the invention, the user could input other types of commands for navigating to a different set of N discrete pages in the sequence. Some examples include: a “Go To” command (interpreted as a command to go to the N discrete pages starting at a designated position in the sequence), an “End” command (interpreted as a command to go to the last N discrete pages in the sequence), and a “Home” command (interpreted as a command to go to the first N discrete pages in the sequence). If S3550 decides that any such command was inputted, processing may proceed to S3560 where PAGEHOLDER is set to an appropriate value, and then return to S3450 of FIG. 4 to update the display.

On the other hand, it is possible for the user to input other types of commands which cause navigation of the current sequence of discrete pages to cease. Examples are when a user decides to download a different webpage or close the browser application altogether. If this occurs (i.e., a “No” decision in S3550), the process S350′ of FIG. 5 may terminate.

It should be noted that FIGS. 4 and 5 are used to illustrate particular example implementations for the second aspect of the present invention, and are not intended to be limiting. For instance, the sequence of operations illustrated in each of these figures may be changed, and certain operations of these figures may be omitted while others may be added, based on design consideration and preferences.

Furthermore, while exemplary embodiments regarding both the first and second aspects of the invention have been described above in terms of current web technologies including standards such as HTML, CSS and HTTP, the invention is not limited to these examples. The present invention may also be implemented using other standards, protocols and data formats for storing, transmitting and presenting content. For instance, the present invention is not limited to the rearrangement and presentation of webpage content only; instead, the principles of the invention described hereinabove may be applied to other types of electronic documents including word processing files, PDF files, etc.

Furthermore, while the examples are contemplated as being implemented on computing devices 100 which operate as client devices running a web browser 200 or some other user agent software locally, the functionality provided by the invention may alternatively be located, in part or in whole, in the network, for example, on a proxy server or transcoding server.

It should also be understood that while the exemplary embodiments include certain combinations of features, some of which are not present in all embodiments, the invention is not limited to the combinations explicitly discussed in the foregoing. Consequently, features that are not explicitly described as depending on each other in order to operate, may or may not be present in a particular embodiment of the invention whether or not they have been described as such above. For the sake of brevity and clarity, all possible permutations of disclosed features have not been explicitly listed, but persons with skill in the art will understand that the omission of certain such combinations does not mean that they are not part of the invention as disclosed through the examples presented herein.

What is claimed is:

1. A method implemented by a web browser for displaying a markup language document comprising:
retrieving the document via a network;
rearranging the document's content into a plurality of displayable discrete pages; and
displaying two or more of the discrete pages at a time.

2. The method of claim 1, wherein the two or more of the discrete pages are displayed side by side.

3. The method according to claim 1, further comprising:
displaying a first set of two or more of the discrete pages;
determining a second set of two or more of the discrete pages to be displayed, the second set being different from the first set, the second set being determined as a result of processing one of a touchscreen gesture, a joystick gesture, a clicking of an on-screen element, and a pressing of a hardware button by a user; and
displaying the second set of two or more discrete pages in place of the first set of two or more discrete pages.

4. The method according to claim 3, wherein
the plurality of discrete pages are defined according to a sequence, and
the one of the touchscreen gesture, clicking of a screen element and pressing of a hardware button is interpreted as a command to navigate to:
the next N discrete pages in the sequence (N≧2), or
the previous N discrete pages in the sequence.

5. The method according to claim 1, wherein
each of the discrete pages are defined as a hierarchical set of elements in markup language code, and
the two or more of the discrete pages are displayed by:
generating N layout elements (N≧2) by cloning a parent element from one of the discrete pages N times, and
populating at least one of the N layout elements with the contents of another of the discrete pages.

6. The method according to claim 5, wherein a script is executed to perform the cloning of the parent element from one of the discrete pages.

7. The method according to claim 5, wherein a script is executed to perform the populating of the at least one of the N layout elements.

8. The method according to claim 5, wherein a counter is maintained for at least one of the N layout elements, the method further comprising:
incrementing or decrementing the counter by N in response to processing one of a touchscreen gesture, a joystick gesture, a clicking of an on-screen element, and a pressing of a hardware button by a user; and
repopulating the at least one of the layout elements with the contents of a corresponding one of the discrete pages whose position in the sequence corresponds to the counter.

9. The method according to claim 5, wherein a script is executed to perform repopulating of the at least one of the layout elements.

10. The method according to claim 5, wherein the parent element is a top-level box defined in cascading style sheet (CSS) code.

11. A non-transitory computer-readable medium on which is stored coded instructions for executing a web browser which, when executed by a computer processor, performs a process comprising:
retrieving a markup language document via a network;
rearranging the document's content into a plurality of displayable discrete pages; and
displaying two or more of the discrete pages at a time.

12. The computer-readable medium of claim 11, wherein the two or more of the discrete pages are displayed side by side.

13. The computer-readable medium according to claim 11, wherein the process further comprises:
displaying a first set of two or more of the discrete pages;
determining a second set of two or more of the discrete pages to be displayed, the second set being different from the first set, the second set being determined as a result of processing one of a touchscreen gesture, a joystick gesture, a clicking of an on-screen element, and a pressing of a hardware button by a user; and
displaying the second set of two or more discrete pages in place of the first set of two or more discrete pages.

14. The computer-readable medium according to claim 13, wherein
the plurality of discrete pages are defined according to a sequence, and
the one of the touchscreen gesture, clicking of a screen element and pressing of a hardware button is interpreted as a command to navigate to:
the next N discrete pages in the sequence (N≧2), or
the previous N discrete pages in the sequence.

15. The computer-readable medium according to claim 11, wherein
each of the discrete pages are defined as a hierarchical set of elements in markup language code, and
the two or more of the discrete pages are displayed by:
generating N layout elements (N≧2) by cloning a parent element from one of the discrete pages N times, and
populating at least one of the N layout elements with the contents of another of the discrete pages.

16. The computer-readable medium according to claim 15, wherein a script is executed to perform the cloning of the parent element from one of the discrete pages.

17. The computer-readable medium according to claim 15, wherein a script is executed to perform the populating of the at least one of the N layout elements.

18. The computer-readable medium according to claim 15, wherein a counter is maintained for at least one of the N layout elements, the method further comprising:
incrementing or decrementing the counter by N in response to processing one of a touchscreen gesture, a joystick gesture, a clicking of an on-screen element, and a pressing of a hardware button by a user; and
repopulating the at least one of the layout elements with the contents of a corresponding one of the discrete pages whose position in the sequence corresponds to the counter.

19. The computer-readable medium according to claim 15, wherein a script is executed to perform repopulating of the at least one of the layout elements.

20. The computer-readable medium according to claim 15, wherein the parent element is a top-level box defined in cascading style sheet (CSS) code.

21. An electronic device including a processor on which is executed the web browser for performing the method of claim 1.
